(19) United States
(12) Patent Application Publication
(10) Pub. No.: US 2006/0162512 A1
(43) Pub. Date: Jul. 27, 2006

(54) Cloth cutting device, cloth cutting method, and cloth cutting and stacking method

(75) Inventor: Nobuo Nasu, Hiroshima (JP)

Correspondence Address: YOUNG & THOMPSON, 745 SOUTH 23RD STREET, 2ND FLOOR, ARLINGTON, VA, 22202, US

(73) Assignee: NAMX CO., LTD., Fukuyama-shi (JP)

(21) Appl. No.: 10/562,689

(22) PCT Filed: Jun. 30, 2004
(86) PCT No.: PCT/JP04/09172

§ 371 Date: Dec. 27, 2005

(30) Foreign Application Priority Data
Jul. 10, 2003 (JP) 2003-273004

(51) Int. Cl. B26D 1/00

(52) U.S. Cl. 83/13

(57) ABSTRACT

[PROBLEMS] To solve problems with a conventional cloth cutting, wherein since a cloth is cut out by bringing a cutter for tailoring into contact with the cloth on a conveyor belt, the cutting of the cloth tended to be obstructed by the conveyor belt and, accordingly, an accurate cutting pattern could not be provided, and also the conveyor belt tended to be damaged by the cutter for tailoring and, accordingly, requires replacement to use for a long period which increased operational difficulty and cost.

[MEANS OF SOLVING PROBLEMS] When a cloth (86) is cut out, the cloth (86) is cut out by a cutter (75) for tailoring without bringing the cutter into contact with a conveyor belt (33) carrying the cloth. For this purpose, a synchronizing member (77) to run in synchronism with the cutter for tailoring is set between the conveyor belt and the cloth.

### TECHNICAL FIELD

The present invention relates to a method and an apparatus in which a procedure of cutting a texture whole cloth or of stacking a cut cloth on a specified position on a texture-stacking table can be effectively conducted for a longer period of time.

### BACKGROUND ART

The texture for a western-style cloth and a Japanese-style cloth is supplied as a very long whole cloth, which is then cut to a desired length. After the cut whole cloth is further cut into respective parts having a variety of specified shapes, the respective parts are sewed in a sewing process to provide desired clothes which are then placed on the market. In case of the dress material for a business suit, the texture per one business suit has a length slightly shorter than two meters and a width of about one meter. The texture having the dimension of this degree is difficult to handle due to the large area though the weight itself is light. Various improved methods have been proposed for automatically or semi-automatically stacking a texture which is obtained by cutting a rolled whole cloth [for example, JP-A-10(1998)-140468 (FIG. 8, and paragraphs 0020 and 0021) and JP-A-10(1998)-140469].

Then, the principle of cutting and the stacking of the texture shown in JP-A-10(1998)-140469 will be described referring to FIGS. 1A to 1D and FIG. 2. In FIG. 1A, two motors or a conveyor-moving motor and a conveyor-rotating motor, and a connecting belt for connecting a pair of rollers are shown. These elements also existing in FIGS. 1B to 1D are omitted for simplicity in FIGS. 1B to 1D. FIG. 2 is a schematic sectional view showing a positional relation among a cutter, the texture and a conveyor belt.

At first, as shown in FIG. 1A, a texture 1 is drawn from a whole cloth to a specified place under a cutter 2 and cut into specified patterns using the cutter 2 (which is movable in right-angled four directions) (in this stage, an endless conveyor belt 6 stretched between an upper end roller 3 and a lower end roller 4 through four conveyor rollers 5a, 5b, 5c and 5d has configuration such that the upper end roller 3 is positioned above the vicinity of the left-side end of a texture-stacking table 7). In this case, the cutter 2 directly cuts the texture in contact with the conveyor belt 6.

An upper sliding section 9 having a guide plate 8 and the upper end roller 3 fixed on the side surface thereof is connected, through a connecting belt 11 stretched by a pair of connecting belt rollers 10a and 10b, to a lower sliding section having the lower end roller 4 fixed on the side surface thereof. A conveyor moving motor 12 is switchably connected to the lower connecting belt roller 10b. A conveyor rotating motor 14 is switchably connected through a clutch 13 to the right-lower conveyor roller 5d among the four conveyor rollers. Upon the turn-on of the conveyor rotating motor 14 and the turn-on of the clutch 13, the conveyor belt 6 moves in a first rotating direction. Upon the turn-off of the conveyor rotating motor 14 and the turn-on of the clutch 13, the motor 14 applies the braking force to the conveyor belt 6 through the clutch 13 or exert the braking function. When the clutch is turned-off, the conveyor rotating motor 14 exerts no work on the conveyor belt 6. In place of the conveyor moving motor and the conveyor rotating motor shown in the drawings, a single motor, for example, may be mounted under the texture-stacking table 7. The said motor is connected with the above roller 5d and the above roller 10b by belts, and only when it is required, the rotation of the motor can be transmitted to the roller 5d and/or the roller 10b by using the clutch.

Even if a conventional method of moving the conveyor belt is attempted in order to convey the cut texture 1a in a forward direction (left-direction of FIG. 1) in this stage, the cut texture 1a cannot be conveyed in the forward direction because the upper end roller 3 reaches the vicinity of the left end in the state of FIG. 1A.

When, however, the conveyor rotating motor 14 and the clutch are turned on in the state of FIG. 1A immediately after the cutting is completed, the rotating force of the motor 14 is thereby transmitted to the conveyor belt 6. Then, the conveyor belt 6 moves such that the top surface (the surface in contact with the texture 1) thereof moves toward the upper end roller 3 and the bottom surface thereof moves toward the lower end roller 4. Accordingly, the entire conveyor belt 6 rotates in a direction shown by an arrow in FIG. 1B to change its state to that shown in FIG. 1C. During the conveyance of the cut texture 1a, a suitable means for applying a braking force to the texture 1 near the whole cloth is employed so that the texture before the cutting is not moved.

When the conveyor moving motor 12 is turned on in this situation while the clutch 13 is turned on and the conveyor rotating motor is turned off to apply the braking force on the top surface side of the conveyor belt 6, the upper sliding section 9 moves in the right-hand direction from the position in FIG. 1C so that the cut texture 1a is guided by the guide plate 8 to be stacked on the texture-stacking table 7. In this situation, the cutter is positioned above the texture 1 before the cutting so that the cutting operation of the texture to be cut subsequently by using the cutter 2 can be performed simultaneously with the stacking operation to shorten the operation time. The repetition of the procedures shown in FIGS. 1A to 1D stacks the textures 1a on the texture-stacking table 7.

Although, in the description referring to FIG. 1, the conveyor belt is rotated and braked by the combination of the conveyor rotating motor and the clutch, the conveyor rotating motor may only rotate the conveyor belt and another braking mechanism may brake the conveyor belt.

The cutter moves in all the four directions to change its position, thereby enabling the texture cutting at a desired position by moving along the running direction of the belt as well as the width direction. The apparatus shown in the drawings includes, in addition to the movable cutter, a texture-stacking mechanism for stacking the texture cut by the cutter, and an endless belt for conveying the whole cloth of the texture to be cut to the position where the cutting is conducted and for moving the texture cut by the cutter onto the texture-stacking table. The length of the texture-stacking table is longer than the length of the texture, and preferably more than twice that of the texture such that when a plurality of the texture stacks are present in the length direction or also when a single texture stack is present, a plurality of stacking positions can be formed and the texture stack may be stacked on any of the positions.

Since the texture in contact with the conveyor belt 6 is directly cut with the cutter 2 in the above conventional texture cutting and stacking apparatus, the cutter 2 frequently damages the conveyor belt 6 to hardly realize the longer life of the apparatus. When the cutting starts not from the edge of the texture but from the inside of the texture, a cut for starting the cutting is hardly formed in the texture so that the desired shape can be hardly obtained by the cutting.

The cutter used for the conventional texture cutting is configured by rotatably engaging the base end of a plate spring 16 with a rotating blade frame 17, and the lower end of the lower blade (cutter) 2 is in point contact with the texture by means of the elasticity of the plate spring 17. When the rotating blade frame 17 is advanced (toward left-hand direction of FIG. 2), the front end of the lower blade 18 scoops up and floats the texture 1 so that the texture in contact with the rotating blade 19 is cut into the specified shape.

The lower blade 2 not only cuts the texture 1 but also damages the conveyor belt 6 by being in contact with the conveyer belt 6 in contact with the bottom surface of the texture. Further, when the cutting with the lower blade 2 starts from the inside of the texture 1, the cutting force is given to not only the texture but also the conveyor belt because the texture is in contact with the conveyor belt 6 so that the cutting force is weakened to hardly make the cut for starting the cutting in the texture 1.

Although the problems in connection with the apparatus for cutting and stacking the texture employing the conveyor have been described, these problems arise not only in the apparatus for cutting and stacking the texture. There is an apparatus in which a worker places a texture on a fixed sheet having both ends fixed, for example, around round bars, and the texture is cut with the cutter having the above configuration and converted from the fixed sheet to another place by the worker. A similar problem to that of the apparatus having the conveyor, or the damage of fixed sheet with the cutter, arises during the cutting by the apparatus.

### DISCLOSURE OF THE INVENTION PROBLEMS TO BE SOLVED BY THE INVENTION

An object of the present invention is to provide, by overcoming the above defects of the prior art, a method of cutting a texture, a method of cutting and stacking a texture and an apparatus for cutting which can achieve a longer life and elevation of cutting accuracy by improving a cutter for cutting a texture.

### MEANS FOR OVERCOMING THE PROBLEMS

The present invention is firstly a method for cutting a texture employing a conveyor belt conveying the texture and a cutter for cutting the texture characterized by comprising the step of cutting the texture, which is not in contact with the conveyor belt, by using the cutter. The present invention is secondly a method for cutting and stacking a texture employing a texture-stacking table, a conveyor belt which conveys the texture by moving itself in a space including that above the texture-stacking table, and a cutter for cutting the texture characterized by comprising the steps of cutting the texture which is not in contact with the conveyor belt by using the cutter; and stacking the cut texture on the texture-stacking table by means of moving the conveyor belt. The present invention is an apparatus for cutting a texture comprising a conveyor belt which runs with the texture to convey the texture, a cutter which is positioned above the conveyor belt and is in contact with the texture for cutting the texture, and a synchronizing member which runs between the texture and the conveyor belt to be synchronized with a horizontal movement of the cutter (these inventions may be summarized to be hereinafter also referred to as “first inventions”). The present invention is fourthly a method for cutting a texture employing a fixed sheet on which the texture is placed and a cutter for cutting the texture characterized by comprising the step of cutting the texture which is not in contact with the fixed sheet by using the cutter. The present invention is fifthly an apparatus for cutting a texture comprising a fixed sheet on which the texture is placed, a cutter which is positioned above the fixed sheet and is in contact with the texture for cutting the texture, and a synchronizing member which runs between the texture and the fixed sheet to be synchronized with a horizontal movement of the cutter (these inventions may be summarized to be hereinafter also referred to as “second inventions”).

The present invention will be hereinafter described in detail.

The texture is not in contact with the conveyor belt during the cutting of the texture on the conveyor belt with the cutter in the first inventions thereby not damaging the conveyor belt with the cutter, and a cut for staring the cutting can be easily formed in the texture in the inner part thereof not in contact with the edge of the texture so that the entire texture can be cut accurately.

In order that the texture is not in contact with the conveyor belt during the cutting in the first inventions, it is required that a space is formed therebetween or a substance is interposed therebetween. However, so long as the conveyor has a function of conveying the texture, the both cannot be always maintained in the non-contact state and the both are maintained in the non-contact state only during the cutting.

For this purpose, a member is positioned in contact with the bottom surface of the texture and the top surface of the conveyor belt during the cutting of the texture by using the cutter. In other words, the member is required to be synchronized with the movement of the cutter (synchronizing member).

When a concave portion is formed on its top surface of the synchronizing member or the surface in contact with the texture, the cutter in contact with the texture can move downward while holding the texture at the front end thereof without being obstructed with the conveyor belt or the synchronizing member itself during the cutting of the texture with the cutter.

Accordingly, substantially all of the cutting force is given to the texture, and the accurate cutting can be started from a point where the cutter is contacted. In this embodiment, all the cutting accuracies are elevated including a case where the cutting is started from the texture edge, compared with the conventional texture cutting where the cutting is started after the texture is floated with the cutter as shown in FIG. 2.

In the second inventions different from the first inventions, the texture is fixed at its position on the fixed sheet without using the conveyor. Also in this case, the fixed sheet is damaged so as not to be used for a longer period of time when the cutting is conducted in accordance with the conventional method.

Accordingly, also in the second inventions, the texture and the fixed sheet are not in contact with each other at least during the cutting.

For this purpose, a member is positioned in contact with the bottom surface of the texture and the top surface of the fixed sheet during the cutting of the texture by using the cutter. The member is required to be synchronized with the movement of the cutter (synchronizing member) similarly to the first inventions. A concave portion is desirably formed on the top surface of the synchronizing member or the surface in contact with the texture.

When the top surface of the synchronizing member is flat in the first inventions and the second inventions, the descending cutter gets in contact with the texture on the surface of the synchronizing member during the cutting so that the cutting is started immediately. The cutting can be conducted on the synchronizing member without changing the shape of the texture so that the cutting itself proceeds smoothly. However, in this case, the contact of the cutter with the synchronizing member through the texture arises a problem that the cutter is likely damaged to shorten its life.

In order to prevent this occurrence, the texture can be cut by using the synchronizing member having the concave portion on its top surface. In this case, the descending cutter gets in contact with the texture during the cutting, and the texture in contact with the cutter deforms towards the inside of the concave portion and is cut in the concave portion so that the cutter is seldom in contact with the inner wall of the concave portion to generate substantially no damage in the cutter.

Because of the absence of the synchronizing member below the texture in contact with the cutter, the texture deforms towards the inside of the concave portion when the cutter descends to get in contact with the texture as described above so that the starting position of the cutting is not fixed. Further, a cut for starting is hardly formed when the cutting is started from the inside of the texture. Anyway, the cutting may not be conducted accurately.

In this case, a texture-holding member may be mounted which is positioned opposite to the synchronizing member with respect to the texture, moves in synchronization with the cutter and presses the texture cut by the cutter on the synchronizing member on the both sides of the concave portion. In this manner, since the texture is held between the both upper edges of the concave portion with high tension to be seldom deformed, the cutter in contact with the texture immediately starts the cutting to conduct the accurate cutting. When the cutting starts from the inside of the texture, the accurate cutting can be started from an intended position because of no relaxation in the texture.

### EFFECTS OF THE INVENTION

Since the conveyor belt conveying the texture or the fixed sheet on which the texture is placed and the texture are in contact with each other at the time of the texture cutting in the conventional texture cutting, the cutter frequently damages the conveyor belt or the fixed sheet during the texture cutting using the cutter. However, the texture can be cut easily and precisely in the present invention because the conveyor belt or the fixed sheet is not in contact with the texture, or the cutter is not influenced by the conveyor belt or the fixed sheet and is in contact with only the texture.

Since, accordingly, the present invention is applicable to various textures such as clothes which require the cutting, and can realize the automation of the cutting step which is heretofore difficult, the present invention can contribute to the complete automation of a plurality of steps including the texture feed, the cutting and the stacking or can conduct the cutting of the texture placed on the fixed sheet without damaging the fixed sheet.

### BEST MODE FOR IMPLEMENTING THE INVENTION

As described earlier, the texture is separated from the conveyor belt or the fixed sheet at least during the cutting in the present invention so that the texture cutting is not directly influenced by the conveyor belt or the fixed sheet. The means therefor is not especially restricted, and ordinarily the synchronizing member which runs in synchronization with the cutter is placed between the conveyor belt or the fixed sheet below the cutter and the texture, and the cutter is descended to cut the texture on the synchronizing member.

The cutter is ordinarily accommodated in a cutter head which runs in the width direction (Y-direction) of the conveyor belt conveying the texture or the fixed sheet. A carriage which runs the cutter head runs in the length direction (X-direction) of the conveyor belt or the fixed sheet. The combination of the running of the cutter head and the carriage makes the cutter reach any position on the texture. The cutter is rotatably supported around an axis so that the cutter can run in any direction and cut the texture at any angle.

For example, the next configuration is applied to run the synchronizing member in synchronization with the cutter.

Below the conveyor belt or the fixed sheet under the cutter head, a slider rail having a whole length the same as or longer than the width of the conveyor belt or the fixed sheet is mounted perpendicular to the running direction of the conveyor belt or the fixed sheet. A slider running in the width direction of the conveyor belt or the fixed sheet along the slider rail is mounted on the slider rail. The slider includes a lower synchronizing magnet which makes the slider run in synchronization with the cutter head or the cutter. Specifically, the cutter is mounted on the cutter head such that the cutter head can move in the longitudinal direction and is fixed in the horizontal direction. An upper synchronizing magnet is mounted near the cutter and is attracted by the lower synchronizing magnet such that the slider and the cutter run in the synchronizing manner.

In addition to the lower synchronizing magnet, a lower sticking magnet is mounted on the slider, and an upper sticking magnet corresponding to the lower sticking magnet is mounted on the synchronizing member. Thereby, the synchronizing member runs in synchronization with the slider, and accordingly also with the cutter.

Although the accurate texture cutting is theoretically possible by the synchronized running of the cutter and the slider in this manner, the movement of the slider in the Y-direction tends to be somewhat delayed with respect to the movement of the cutter in the Y-direction so that the sufficiently accurate cutting cannot be sometimes conducted. In order to prevent this occurrence, a timing belt for the cutter head employed for moving the cutter head accommodating the cutter on the guide rail and a timing belt for the slider moving the slider along the slider rail are synchronized with each other securely. The accurate cutting can be possible by, for example, binding the both timing belts by gears or an endless belt.

For the implementing the cutting, the cutter is positioned above the texture before the start of the cutting and then descended to get in contact with the texture. In this situation, the texture to be cut is in contact with the synchronizing member at its contact point with the cutter. When a trench is formed on the top surface of the synchronizing member, the cutter is present above the trench just like floating.

When the texture is cut by running the cutter in the former situation, the cutting can be conducted precisely because the texture is cut on the synchronizing member which is less deformable than the conveyor belt or the fixed sheet. Further, the synchronizing member is less expensive and only placed on the conveyor belt or the fixed sheet so as to be easily and inexpensively replaced after it is damaged. In the cutting by using the cutter in the latter situation, the cutting can be conducted more easily without being influenced by the other members because the texture is floated. No damage is generated in the other members, and no replacement of the conveyor belt or the fixed sheet is required.

Then, Example 1 of an apparatus for cutting and stacking a texture in accordance with the present invention will be described referring to FIGS. 3 to 7. The present invention shall not be restricted to Example 1.

As shown in FIG. 3, a numeral 21 denotes four legs positioned as each one pair in front and rear parts. Upper frames 22 and lower frames 23 span between top inner sections and between bottom inner sections, respectively, of the leg pairs of this side and of that side. A pair of guide rails 24 for carriage span along the outer surfaces of the pair of the upper frames 22, and upper guide rails 25 for a conveyor belt span along the inner surfaces thereof.

A pair of supporting bars 26 span between the pair of the lower frames 23. A conveyor belt rotating motor 27 is mounted on the right end in FIG.3 of the lower frame 23 of this side, and a conveyor moving motor 28 is mounted on the left end. Lower guide rails 29 for the conveyor belt span on the inner surfaces of the lower frames 23. A rectangular texture-stacking table 30 spans slightly lower than the upper guide rails 25 for the conveyor belt and between the inner surfaces thereof.

Rectangular guide plates 31 are engaged in the pair of the respective upper guide rails 25 for the conveyor belt and run along the rails, and an upper end roller 32 spans between the both guide plates 31. Similarly, rectangular guide plates (not shown) run along the pair of the respective lower guide rails 29 for the conveyor belt, and a lower end roller (not shown, and corresponding to the numeral 4 in FIG. 1) spans between the both guide plates. An endless conveyor belt 33 extends between the upper end roller 32 and the lower end roller through two pairs of top and bottom conveyor rollers (not shown, and corresponding to the numeral 5a to 5d in FIG. 1) near the conveyor belt rotating motor 27.

Carriages 34 running along the pair of the respective guide rails 24 are mounted, and a hollow connecting member 36 having a pair guide rails 35 for a cutter head which are parallel to each other one its one side surface spans between the both carriages 34. A cutter head 37 is mounted on the pair of the guide rails 35 and can run along the hollow connecting member 36.

A frame 38 having a longitudinal length longer than that of the connecting member 36 is mounted on the cutter head 37. The frame 38 having, on its one side surface, a guide 39 having a concave section towards the guide rail is engaged with the guide rail 35 for the cutter head by using the guide 39 for running. On the other side surface of the frame 38, the base portion of an L-shaped metal attachment 40 for holding the upper synchronizing magnet having an intermediate slant is fixed with a screw 41. A round aperture 42 formed in the center of the horizontal section of the metal attachment 40 has a concave section facing sideways on its inner surface. A plate 44 for mounting an upper synchronizing magnet having, on its center, an aperture 43 which is formed by making crescent-shaped swelled parts on both ends of an angular aperture is engaged with the concave section. An upper synchronizing magnet 45 is fixed on the bottom surface of the plate 44 symmetrically on both sides of the aperture 43.

A lower guide frame 46 extending substantially parallel to the connecting member 36 between the both carriages 34 in a corresponding place lower than the upper frame 22 and having a downward swelled section on its center spans to run with the carriages. A concave slider rail 47 extends in the central swelled section of the lower guide frame 46 along its entire length. A plate-like slider 49 is engaged in the slider rail 47 to run therein while holding a lower larger diameter section of an upward-directing rotation pin 48. A plate 50 for attaching lower synchronizing magnet is fixed at the top edge of the rotation pin 48, and a pair of lower synchronizing magnets 51 are mounted in a place near to the outer edge of the attaching plate 50 and corresponding to that on which the upper synchronizing magnets exist. Further, a pair of lower sticking magnets 52 are symmetrically mounted near the central part.

The both ends of the lower guide frame 46, the lower synchronizing magnets 51 and the lower sticking magnets 52 are positioned in contact with or near to the conveyor belt 33.

A pair of mounting members 53 are placed and longitudinally separated on the other surface of the top section of the frame 38, and a guide axis 51 spans between the both mounting members 53. A bearing 55 is mounted along the guide axis 54 in a longitudinally movable manner, and a longitudinally movable frame 56 is fixed around the bearing 55 to move longitudinally with the bearing 55. The longitudinal movement of the frame 56 is conducted by a cylinder 57 for longitudinally moving the cutter.

A motor 58 for rotating the cutter is mounted on the frame 56 such that the rotation of the motor 58 is transmitted, by means of a pulley 59 for rotating the cutter, to a hollow center axis 62 supported by a center axis bearing 61, and then to an air joint 60 for moving a lower blade engaged in the center axis 62. A blade frame 63 is fixed on the opposite end of the center axis 62 of the air joint 60.

A blade aperture slightly above the lower end of the blade frame 63 is engaged with a blade axis 64, and a blade 67 having a round-blade shape is rotatably mounted around the blade axis 64 by a blade axis bearing 65 and a nut 66 for holding the blade. Although the round blade is employed as the blade, a rotation blade having a polygonal shape may be also used.

A motor 68 for rotating the blade is mounted slightly lower than the center axis 62 of the blade frame 63 so that the rotation of the motor 68 for rotating the blade is transmitted in the order of a motor axis 69, an upper gear 70, a belt 70a and a lower gear 70b to rotate the round blade 67.

An air hose 71 is connected to the center axis 61, and the other end of the air hose 71 is connected to an air cylinder 72 for moving the lower blade. A lower blade axis 73 connected to the lower end of the air cylinder 72 is communicated to a lower blade 75 held in a lower blade holder 74 by penetrating the blade frame 63. A cutter is configured by the lower blade 75 and the round blade 67.

The lower end section of the blade frame 63 is bent horizontally, and a communication pin 76 for communicating the plate 44 for mounting the upper synchronizing magnet to the blade frame 63 is engaged with the bent section.

A synchronizing member 77 shown in FIG. 6 and in contact with the conveyor belt 33 is placed on the conveyor belt 33 above the slider rail 47. The synchronizing member 77 includes a substrate 78 and a pair of projection members 79 formed on the substrate such that a trench 80 is formed between the projection members. A pair of upper sticking magnets are fixed outside the 25 projection members 79. The projection members theremselve4s may be used as the magnets without employing the upper sticking magnets.

A pair of belt-like members 82 are mounted facing upward in the end of the upper frame 22 near the conveyor belt rotating motor 27, and a triangular member 83 for holding a whole cloth is mounted on the rear surface of the top end of the belt-like members 82. The whole cloth 85 is held around a whole cloth bar 84 spanning between the both whole cloth holding members 83, and the whole cloth is supplied on the conveyor belt 33 as a texture 86. Then, the texture is cut by the round blade 67 and the lower blade 75 to specified patterns, and the cut patterns are stacked on the texture-stacking table 30 by being guided by a slanted guide plate 88 mounted on the front end of the conveyor belt 33 after the backward movement of the conveyor belt 33.

Then, the cutting in the above Example will be described referring to schematic views of FIGS. 7A to C showing the cutting procedures in addition to FIGS. 3 to 6.

The round blade 67 and the lower blade 75 move in the width direction of the texture or the Y-direction shown in FIGS. 3 and 5 when the cutter head 37 runs along the connecting member 36, and further move in the length direction of the texture or the X-direction shown in FIGS. 3 and 5 when the carriages 34 run along the upper frames 22. The round blade 67 and the lower blade 75 can be positioned at any angle with respect to the X-direction and the Y-direction by rotating the cutter head 37 around the center axis 60 (θ direction in FIG. 5).

The synchronizing member 77 is placed on the conveyor belt 33 during the procedures of the cutting and the stacking of the texture. The upper sticking magnets 81 of the synchronizing member 77 and the lower sticking magnets 52 on the plate 50 for mounting the lower synchronizing magnets attract each other so that the synchronizing member 77 runs in synchronization with the plate 50 for mounting the lower synchronizing magnets. The lower synchronizing magnets 51 on the plate 50 and the upper synchronizing magnets 45 of the metal attachment 40 for holding the upper synchronizing magnets attract each other so that the plate 50 for mounting the lower synchronizing magnets runs in synchronization with the metal attachment 40. The positional relation in the horizontal direction among the metal attachment 40 for holding the upper synchronizing magnets, the round blade 67 and the lower blade is unchanged so that the round blade 67 and the lower blade 75 are always positioned in the trench 80 of the synchronizing member 77 or its upward space even if the cutter head 37 takes any movement when the round blade 67 and the lower blade 75 are originally designed to be positioned in the trench 80 of the synchronizing member 77 or its upward space.

The texture 86 is drawn from the whole cloth 85 to a specified position below the cutter head 37 (refer to FIG. 1) for cutting the texture. Since the synchronizing member 77 is present on the conveyor belt 33 below the cutter head 37, the texture 86 is in contact with the top surface of the of the synchronizing member 77 below the cutter head 37 as shown in FIG. 7A and is not in contact with the conveyor belt 33. In this situation, the round blade 67 and the lower blade 75 are positioned above the texture 86, and the lower end of the round blade 67 is positioned lower than the front end of the lower blade 75.

When the round blade 67 and the lower blade 75 are then descended while the positional relation between the round blade 67 and the lower blade 75 is maintained, at first only the round blade 67 gets in contact with the texture 86 as shown in FIG. 7B. Since the trench 80 or the space is present below the texture 86 with which the round blade is contacted, a cut for starting the cutting is formed while the texture 86 maintains the downward tensile strength by the round blade 86.

Then, when the lower blade 75 is rotated downward around the connecting section between the lower blade 75 and the lower blade holder 74, the lower blade 75 together with the round blade 67 gets in contact with the texture 86 in the cut for starting the cutting. When, in the situation, the lower blade 75 and the round blade 67 are moved in the X-direction or the Y-direction by the running of the carriages 34 or the cutter head 37, respectively, or the cutter head 37 is rotated in the θ direction around the center axis 60, the texture 86 can be cut into desired shapes. Since, also in this case, the trench 80 or the space is present below the texture 86 with which the round blade is contacted, the lower blade 75 and the round blade 67 can cut only the texture 86 without being influenced by the conveyor belt 33 different from the case of FIG. 2 when the lower blade 75 and the round blade 67 get in contact with the texture for the cutting. Since, further, the texture 86 to be cut is maintained with the tensile strength between the projection members 79 on the both sides of the trench 80 of the synchronizing member 77, the lower end of the round blade 67 firstly in contact with the texture 86 can precisely form the cut for starting the cutting in the texture 86 so that the cutting can be conducted with higher accuracy.

Cut patterns 87 are stacked on the texture-stacking table by the procedures, for example, shown in FIGS. 1B to 1D, and then transferred to a consecutive sewing step. Then, a new texture is supplied on the conveyor belt, and the cutting and the stacking are repeated.

Next, an example of driving the conveyor belt (Example 2) in the method of stacking the texture in accordance with the present invention will be described referring to FIGS. 8A and 8B. The description of elements the same as those of Example 1 is omitted by attaching the same numerals thereto.

In the present Example, the base end of a conveyor belt 33a is fixed to an axis 89, and its front end is rolled on a reel-up roller 90. FIG. 8A shows a situation in which the texture 86 is transferred to a position above a receiving conveyor 91 for stacking by moving the reel-up roller 90 to the left side in the drawing while the texture 86 is placed on the conveyor belt 33a. A numeral 92 denotes a cramp for fixing the texture.

The texture 86 is cut in the situation of FIG. 8A by employing the round blade 67 and the lower blade (not shown). In this case, the presence of the synchronizing member 77 can cut the texture 86 without the contact with the conveyor belt 33a similarly to Example 1, thereby generating similar effects.

Then, the reel-up roller 90 moves in the right-hand direction as shown in FIG. 8B, the conveyor belt 33a is reeled up by the reel-up roller 90 so that the cut texture 86 is transferred on the receiving conveyor 91. Then, the reel-up roller 90 moves in the left-hand direction in the drawings to return to the situation of FIG. 8A. The texture cutting and the transfer of the cut texture on the receiving conveyor 91 are again repeated so that the stacking of the cut texture is conducted.

Then, an example of a method of cutting the texture employing the fixed sheet in accordance with the present invention will be described referring to FIG. 9.

A pair of holding axes 96 are mounted in the vicinities of the right end and the left end of a pair of frames 95 spanning between right and left supporting elements 94 having hook-shaped bent sections 93 on their tops. A fixed sheet 97 spans between the pair of the holding axes 96 such as to maintain a tensile strength. The texture 86 prepared by cutting the whole cloth to a specified shape is manually placed on the fixed sheet 97. The cutting is conducted through the cutting means having substantially the same configuration as that of Example 1 of FIGS. 4 to 7.

The cutter 67 running in synchronization with the synchronizing member 77 in contact with the bottom surface of the texture cuts the texture 86 in the situation in which the texture 86 is not in contact with the fixed sheet 97 so that the texture 86 can be cut without damaging the fixed sheet 97 similarly to Examples 1 and 2. Since no automatic stacking can be conducted in the present Example, the stacking is conducted by manually stacking the texture cut to the specified shape or by utilizing an automatic stacking apparatus. The fixed sheet in FIG. 9 may be replaced with an endless sheet spanning between the pair of the holding axes 96.

Then, an example of a texture-holding member in a method of cutting or cutting and stacking the texture in accordance with the present invention (Example 4) will be described referring to FIGS. 10 to 12.

Example 4 relates to a method of elevating the cutting accuracy by preventing the deformation of the cut surface of the texture in the direction of the concave section during the cutting of the texture by the cutter by employing the synchronizing member having the concave section, and further of smoothly conducting the cutting also when the cutting starts from the inside of the texture. Example 4 is a modification of the preceding Examples, and the description of elements the same as those of the preceding Examples is omitted by attaching the same numerals thereto.

In the present Example, a mounting device 102 having an axis 101 is fixed on the periphery of the plate 44 for mounting the upper synchronizing magnets having the opening. A metal member 103 having a curved central part for holding the texture (texture-holding member) prepared by bending a thin metal bar to a U-shape and placing its front end in the horizontal direction is supported rotatably around the axis 101. A ring 104 for holding the metal bar having substantially the same shape as that of the plate 44 for mounting the upper synchronizing magnets is mounted movable in the longitudinal direction slightly above the plate 44 (FIG. 10A).

When the ring 104 for holding the metal bar is descended in this situation, the ring 104 gets in contact with the front horizontal part of the metal member 103 for holding the texture so as to move the entire metal member 103 downward around the axis 101. Thereby, the curved part of the metal member 103 gets in contact with the texture 86 which is pressed toward the pair of the projection members 79 of the synchronizing member 77 so that the texture 86 between the projection members 79 is strained (FIG. 10B).

When the blade 67 in the shape of the round blade is descended in this situation, the texture is cut by the blade 67 without the deformation of the texture because the texture is strained. Also, when the cutting starts from the inside of the texture 86, the texture 86 can be accurately cut into the specified shape without providing burden to the blade. Further, depending on necessity, the cut texture can be stacked on the specified position.

Since the above embodiments are described only for examples, the present invention is not limited to the above embodiments and various modifications or alternations can be easily made therefrom by those skilled in the art without departing from the scope of the present invention.

### BRIEF DESCRIPTION OF DRAWINGS

FIGS. 1A to 1D are schematic views showing principals of cutting and stacking of texture applicable to the present invention in addition to the prior art.

FIG. 2 is a schematic sectional view showing a positional relation among a cutter, the texture and a conveyor belt.

FIG. 3 is a perspective view showing Example 1 of an apparatus for cutting and stacking a texture in accordance with the present invention.

FIG. 4 is a longitudinal side sectional view of the cutter head of FIG. 3.

FIG. 5 is a plan view of the principal part of FIG. 4.

FIG. 6 is a perspective view of the synchronizing member of FIG. 5.

FIGS. 7A to 7C are schematic views illustrating procedures of cutting a texture by using an apparatus of Example 1.

FIGS. 8A and 8B are schematic views illustrating procedures of cutting and conveying a texture in accordance with Example 2.

FIG. 9 is a schematic view illustrating a method of cutting a texture which employs a fixed sheet in accordance with Example 3 of the present invention.

FIGS. 10A and 10B are schematic longitudinal sectional views showing a texture-holding member in accordance with Example 4 of the present invention, and FIG. 10A shows a situation where the texture-holding member is positioned above the texture and FIG. 10B shows a situation where the texture-holding member is lowered to press the texture toward projection members.

FIG. 11 is a longitudinal sectional view taken along a line A-A of FIG. 10B.

FIG. 12 is a plan view of FIG. 11 corresponding to FIG. 5.

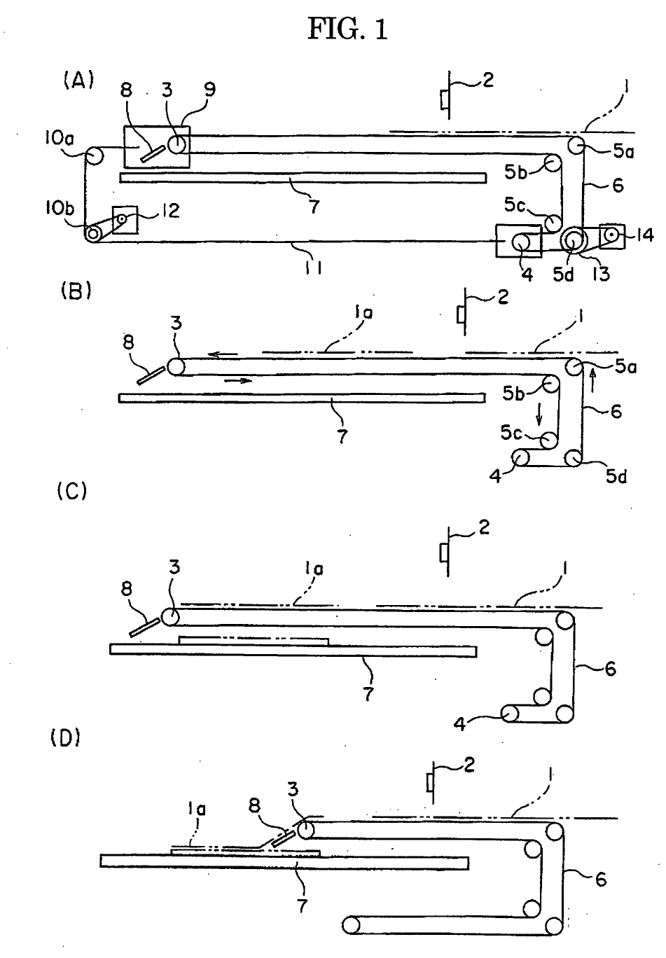

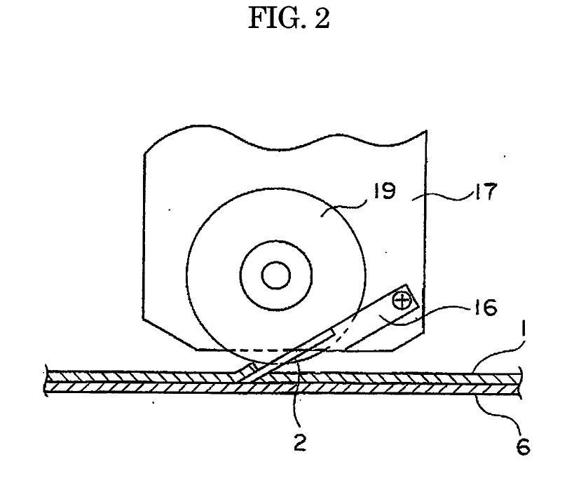

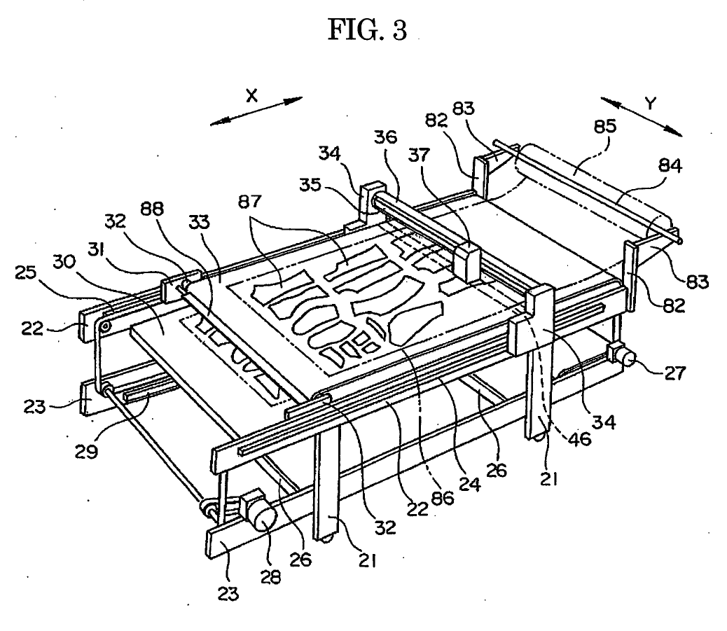

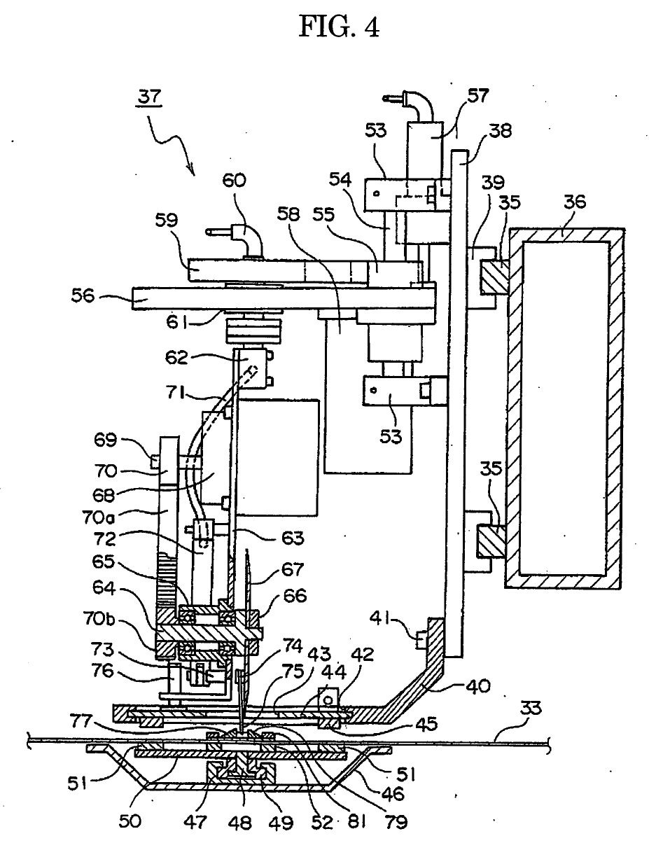

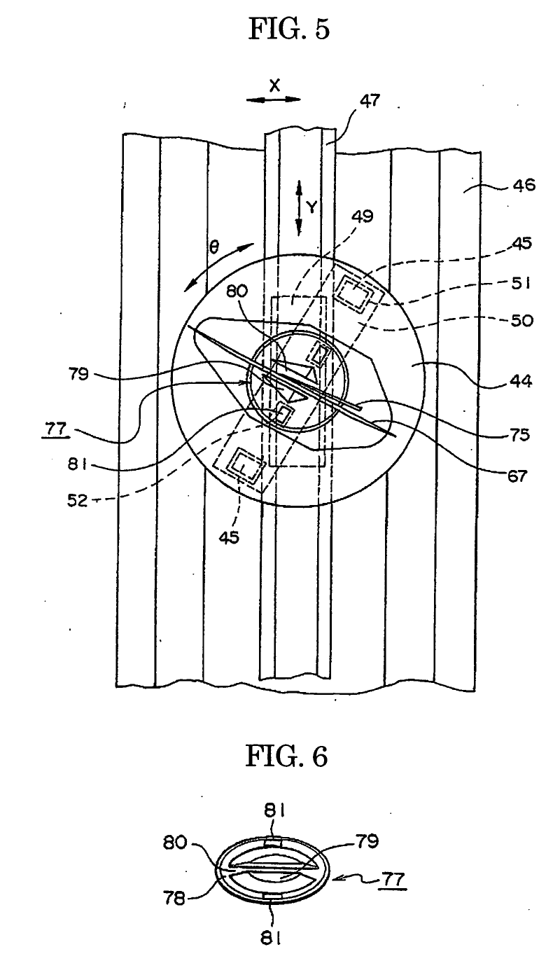

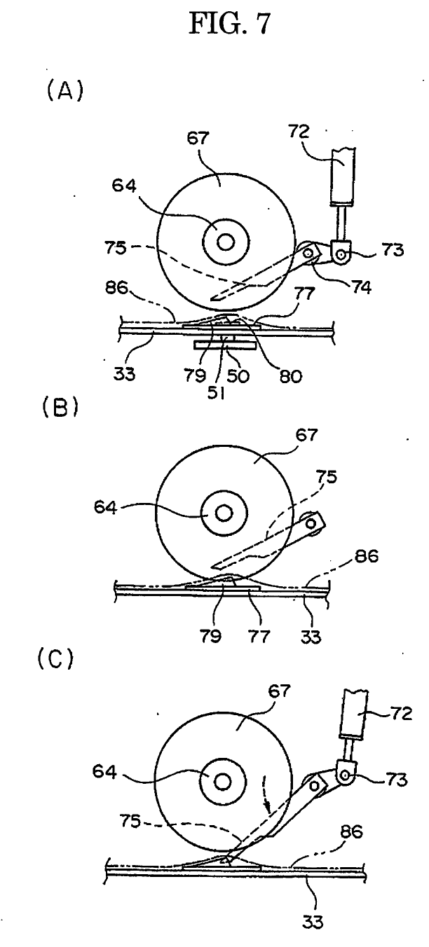

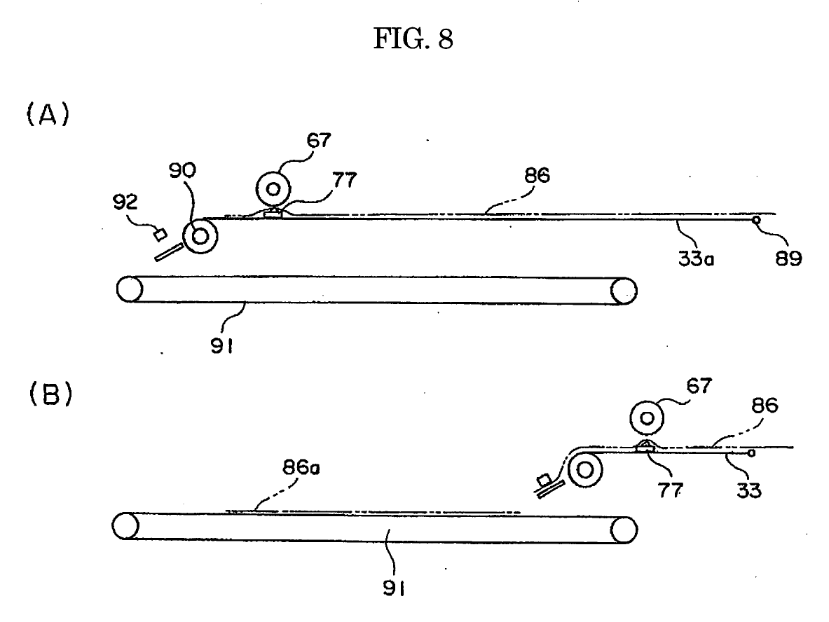

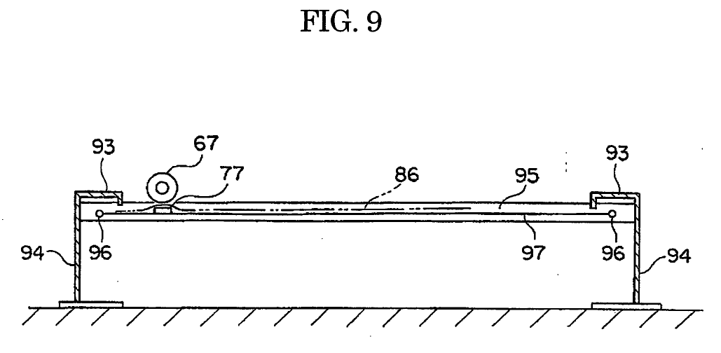

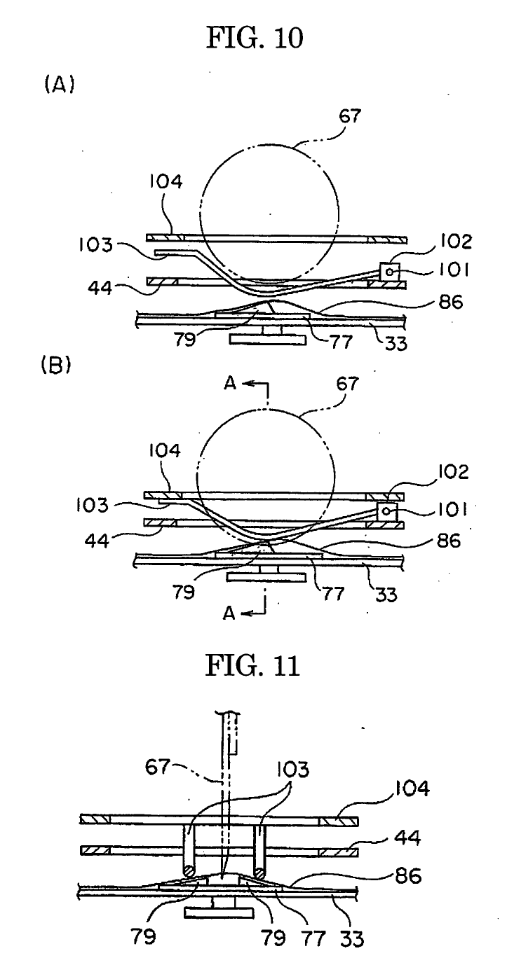

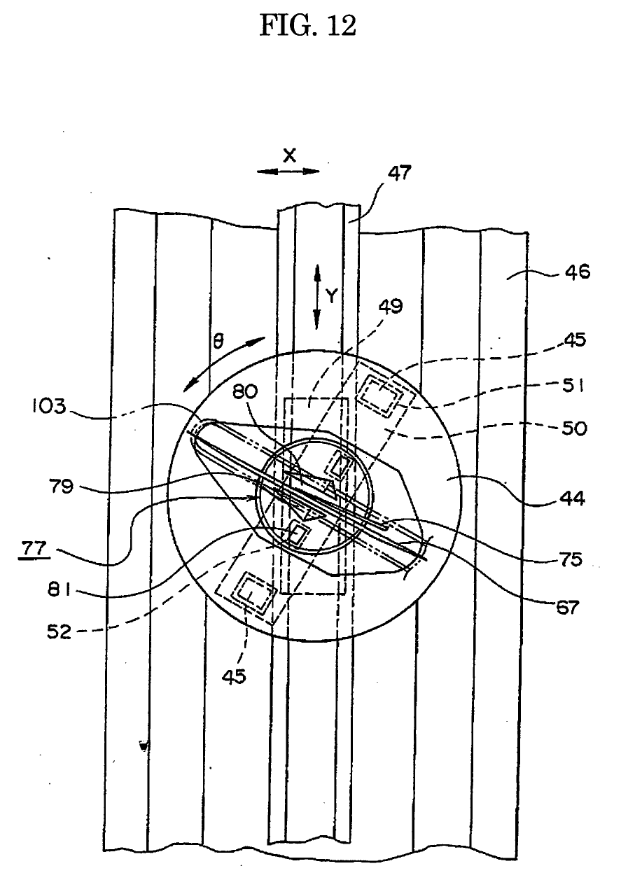

### DESCRIPTION OF SYMBOLS

30 texture-stacking table
33 conveyor belt
34 carriage
35 guide rail for cutter head
36 connecting member
37 cutter head
40 metal attachment for holding upper synchronizing magnet
44 plate for mounting upper synchronizing magnet
45 upper synchronizing magnet
47 slider rail
49 slider
50 plate for attaching lower synchronizing magnet
51 lower synchronizing magnet
52 lower sticking magnet
56 longitudinally movable frame
62 center axis
67 blade
75 lower blade
77 synchronizing member
79 projection member
80 trench
81 upper sticking magnet
85 whole cloth
86 texture
87 cut pattern

1. A method for cutting a texture employing a conveyor belt conveying the texture and a cutter for cutting the texture characterized by comprising the step of cutting the texture which is not in contact with the conveyor belt by using the cutter.

2. A method for cutting and stacking a texture by employing a texture-stacking table, a conveyor belt which conveys the texture by moving itself in a space including that above the texture-stacking table, and a cutter for cutting the texture characterized by comprising the steps of
cutting the texture which is not in contact with the conveyor belt by using the cutter; and
stacking the cut texture on the texture-stacking table by means of moving the conveyor belt.

3. An apparatus for cutting a texture comprising a conveyor belt which runs with the texture to convey the texture, a cutter which is positioned above the conveyor belt and is in contact with the texture for cutting the texture, and a synchronizing member which runs between the texture and the conveyor belt to be synchronized with a horizontal movement of the cutter.

4. The apparatus for cutting the texture as claimed in claim 3 further comprising a slider placed below the conveyor belt and running along a slider rail spanning substantially parallel to a running direction of the cutter; an upper synchronizing magnet which is attracted by a lower synchronizing magnet mounted on the slider; a top magnet mounting plate having fixed horizontal positional relation with the cutter and having the upper synchronizing magnet; and a top sticking magnet mounted on the synchronizing member and attracted by a bottom sticking magnet mounted on the slider.

5. The apparatus for cutting the texture as claimed in claim 4, wherein the synchronizing member has a concave portion on its top surface.

6. The apparatus for cutting the texture as claimed in claim 5 further comprising a texture-holding member which is positioned opposite to the synchronizing member with respect to the texture, moves in synchronization with the cutter and presses the texture cut by the cutter on the synchronizing member.

7. A method for cutting a texture employing a fixed sheet on which the texture is placed and a cutter for cutting the texture characterized by comprising the step of cutting the texture which is not in contact with the fixed sheet by using the cutter.

8. An apparatus for cutting a texture comprising a fixed sheet on which the texture is placed, a cutter which is positioned above the fixed sheet and is in contact with the texture for cutting the texture, and a synchronizing member which runs between the texture and the fixed sheet to be synchronized with a horizontal movement of the cutter.

9. The apparatus for cutting the texture as claimed in claim 8, wherein the synchronizing member has a concave portion on its top surface.

10. The apparatus for cutting the texture as claimed in claim 9 further comprising a texture-holding member which is positioned opposite to the synchronizing member with respect to the texture, moves in synchronization with the cutter and presses the texture cut by the cutter on the synchronizing member.
